(19) United States
(12) Patent Application Publication
(10) Pub. No.: US 2025/0097524 A1
(43) Pub. Date: Mar. 20, 2025

(54) LIVE STREAM PROCESSING METHOD, TERMINAL DEVICE AND STORAGE MEDIUM

(71) Applicant: Beijing Zitiao Network Technology Co., Ltd., Beijing (CN)

(72) Inventor: Donghui ZHANG, Beijing (CN)

(21) Appl. No.: 18/830,112

(22) Filed: Sep. 10, 2024

(30) Foreign Application Priority Data
Sep. 15, 2023 (CN) 202311199795.9

(51) Int. Cl. H04N 21/44; H04N 21/2187; H04N 21/239; H04N 21/442

(52) U.S. Cl. CPC H04N 21/44004; H04N 21/2187; H04N 21/2393; H04N 21/44209

(57) ABSTRACT

The present disclosure provides a live stream processing method and apparatus, a terminal device, and a storage medium, and the method includes: acquiring a network bandwidth and a round-trip time; acquiring a maximum buffer and a minimum buffer preset for a live stream when playing is started; determining a first buffer for the live stream during a playing starting stage based on the network bandwidth, the round-trip time, the maximum buffer, and the minimum buffer; and starting to play the live stream based on the first buffer.

### CROSS-REFERENCE TO RELATED APPLICATION

The present application claims the priority to Chinese Patent Application No. 202311199795.9, filed on Sep. 15, 2023, the entire disclosure of which is incorporated herein by reference as portion of the present application.

### TECHNICAL FIELD

Embodiments of the present disclosure relate to a live stream processing method and apparatus, a terminal device, and a storage medium.

### BACKGROUND

When network jitter occurs, stuttering may occur in live stream. Therefore, a terminal device may increase the playing buffer for the live stream to avoid stuttering caused by network jitter.

At present, the terminal device may set the same live stream buffer for all clients, thereby preventing stuttering for the user when watching the live stream. For example, the terminal device may set live stream buffer data of 10 seconds. Thus, in response to the download speed of live stream data being less than the playing speed of the live stream data, the terminal device may avoid live stream stuttering based on the live stream buffer data of 10 seconds. However, this will cause higher delay in the live stream.

### SUMMARY

Embodiments of the present disclosure provides a live stream processing method and apparatus, a terminal device, and a storage medium.

In a first aspect, the embodiments of the present disclosure provide a live stream processing method, and the method includes:
acquiring a network bandwidth and a round-trip time;
acquiring a maximum buffer and a minimum buffer preset for a live stream when playing is started;
determining a first buffer for the live stream during a playing starting stage based on the network bandwidth, the round-trip time, the maximum buffer, and the minimum buffer; and
starting to play the live stream based on the first buffer.

In a second aspect, the embodiments of the present disclosure further provide a live stream processing apparatus, and the live stream processing apparatus includes a first acquisition module, a second acquisition module, a determination module, and a starting module;
the first acquisition module is configured to acquire a network bandwidth and a round-trip time;
the second acquisition module is configured to acquire a maximum buffer and a minimum buffer preset for a live stream when playing is started;
the determination module is configured to determine a first buffer for the live stream during a playing starting stage based on the network bandwidth, the round-trip time, the maximum buffer, and the minimum buffer; and
the starting module is configured to start to play the live stream based on the first buffer.

In a third aspect, the embodiments of the present disclosure further provide a terminal device including a processor and a memory;
the memory is configured to store computer-executable instructions; and
the processor is configured to execute the computer-executable instructions stored in the memory to implement the live stream processing method according to the first aspect or any embodiment in the first aspect.

In a fourth aspect, the embodiments of the present disclosure further provide a non-transitory computer-readable storage medium, which stores computer-executable instructions; and a processor, when executing the computer-executable instructions, implements the live stream processing method according to the first aspect or any embodiment in the first aspect.

The present disclosure provides a live stream processing method and apparatus, a terminal device, and a storage medium, and the live stream processing method includes: acquiring a network bandwidth and a round-trip time; acquiring a maximum buffer and a minimum buffer preset for a live stream when playing is started; determining a first buffer for the live stream during a playing starting stage based on the network bandwidth, the round-trip time, the maximum buffer, and the minimum buffer; and starting to play the live stream based on the first buffer. In the above-mentioned live stream processing method, because the terminal device can determine the first buffer when the playing of the live stream is started in combination with the network status, the accuracy of the first buffer is high, and because stuttering is prone to occur in a period when the playing of the live stream is started, the stuttering occur in a period when the playing of the live stream is started can be avoided by setting the first buffer when playing is started. Moreover, the first buffer is different from a live stream buffer after normal playing of the live stream, and would not affect a live stream delay after the playing of the live stream is started. Thus, not only can the live stream be prevented from stuttering, but also the live stream delay can be reduced.

### BRIEF DESCRIPTION OF DRAWINGS

In order to more clearly illustrate the technical solutions of the embodiments of the present disclosure, the drawings that need to be used in description of the embodiments will be briefly described in the following. Apparently, the drawings in the following description are only some embodiments of the present disclosure. For those skilled in the art, other drawings can also be obtained based on these drawings without any inventive work.

FIG. 1 is a schematic diagram of an application scenario provided by the embodiments of the present disclosure;

FIG. 2 is a schematic flowchart of a live stream processing method provided by the embodiments of the present disclosure;

FIG. 3 is a schematic diagram of a process of determining a network quality level provided by the embodiments of the present disclosure;

FIG. 4 is a schematic diagram of starting to play a live stream provided by the embodiments of the present disclosure;

FIG. 5 is another schematic diagram of starting to play a live stream provided by the embodiments of the present disclosure;

FIG. 6 is a schematic diagram of a method of determining a first buffer provided by the embodiments of the present disclosure;

FIG. 7 is a schematic diagram of a process of determining a first buffer provided by the embodiments of the present disclosure;

FIG. 8 is a schematic diagram of another process of determining a first buffer provided by the embodiments of the present disclosure;

FIG. 9 is a schematic structural diagram of a live stream processing apparatus provided by the embodiments of the present disclosure; and

FIG. 10 is a schematic structural diagram of a terminal device provided by the embodiments of the present disclosure.

### DETAILED DESCRIPTION

Exemplary embodiments will be described in detail here, and the exemplary embodiments are shown in the drawings. In the case where the following description refers to the drawings, same numbers in different drawings represent the same or similar elements unless otherwise indicated. The implementations described in the following exemplary embodiments do not represent all implementations consistent with the present disclosure. Rather, they are merely examples of apparatuses and methods consistent with some aspects of the present disclosure, as detailed in the appended claims.

For ease of understanding, concepts involved in the embodiments of the present disclosure are explained below.

A terminal device is a device having wireless receiving and sending functions. The terminal device may be deployed on land, e.g., in a room or outdoors, held in hand, worn, or on a vehicle. The terminal device may be a mobile phone, a Pad, a computer with wireless receiving and sending functions, a virtual reality (VR) terminal device, an augmented reality (AR) terminal device, a wireless terminal in industrial control, an vehicle-mounted terminal device, a wireless terminal in self driving, a wireless terminal device in remote medical, a wireless terminal device in smart grid, a wireless terminal device in transportation safety, a wireless terminal device in smart city, a wireless terminal device in smart home, a wearable terminal device, or the like. The terminal device involved in the embodiments of the present disclosure may also be referred to as a terminal, user equipment (UE), an access terminal device, a vehicle-mounted terminal, an industrial control terminal, a UE unit, a UE station, a mobile station, a mobile platform, a distant station, a remote terminal device, a mobile device, a UE terminal device, a wireless communication device, a UE agent, a UE apparatus, or the like. The terminal device may be stationary or mobile.

In the related art, when network jitter occurs, stuttering may occur in live stream. For example, when network jitter occurs, the download speed of live stream data is less than the playing speed of the live stream data, and thus live stream stuttering may occur. In order to avoid the live stream stuttering, the terminal device may set the same live stream buffer for all clients. For example, the terminal device may set live stream buffer data of 10 seconds. Thus, when network jitter occurs, due to the presence of the live stream buffer data of 10 seconds, stuttering can be avoided. However, live stream stuttering usually takes place when the first frame of image is rendered. If the terminal device sets a large buffer, after playing is started, the delay during live streaming is high, which in turn leads to poor user experience.

In order to solve the technical problems in the related art, the embodiments of the present disclosure provide a live stream processing method. The terminal device may acquire a network bandwidth and a round-trip time and acquire a maximum buffer and a minimum buffer preset for a live stream when playing is started. A network quality level is determined based on the network bandwidth and the round-trip time. A first buffer for the live stream when playing is started is determined based on the network quality level, the maximum buffer, and the minimum buffer. In response to the current buffer being greater than or equal to the first buffer, the terminal device may start to play the live stream. In response to the current buffer being smaller than the first buffer, the terminal device may wait until the current buffer of the live stream is equal to the first buffer, or wait for 1 second, before starting to play the live stream. In this way, because the terminal device can determine the first buffer when the playing of the live stream is started in combination with the network status, the accuracy of the first buffer is high. For a user for whom the network status is good, the network bandwidth can be saved. Moreover, because the terminal device optimizes only the buffer during the playing starting stage, the live stream buffer after starting to play may not be affected. Therefore, a low value may be set for the live stream buffer after starting to play. Thus, not only can live stream stuttering be avoided, but also the live stream delay can be educed. The user experience is enhanced.

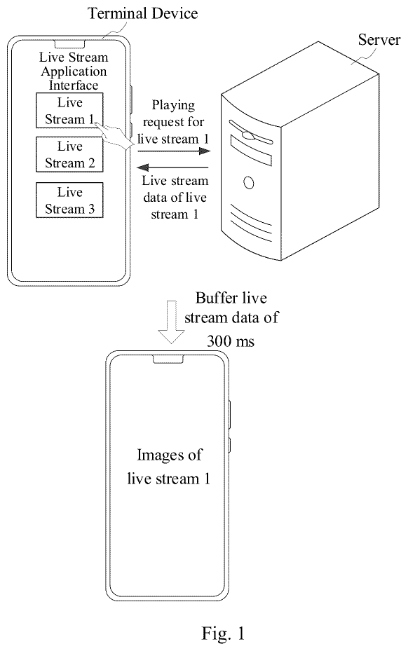

An application scenario of the embodiments of the present disclosure is described below with reference to FIG. 1.

FIG. 1 is a schematic diagram of an application scenario provided by the embodiments of the present disclosure. Referring to FIG. 1, a terminal device and a server are included. A display interface of the terminal device is a live stream application interface including live stream 1, live stream 2, and live stream 3. When a user clicks on the live stream 1, the terminal device may send a playing request for the live stream 1 to the server, and the server may send live stream data of the live stream 1 to the terminal device. After the terminal device buffers live stream data of 300 ms, the terminal device may play images of the live stream 1. In this way, during the playing starting stage of the live stream 1, the terminal device can buffer enough live stream data and thus avoid stuttering of the live stream 1 when playing is started. After the playing of the live stream 1 is started, because the terminal device includes the live stream buffer (the buffer is different from the buffer when playing is started) of the live stream 1, stuttering during live streaming can be avoided. Because the terminal device can distinguish between the buffer playing is started and the buffer during live streaming, the buffer when playing is started does not affect the live stream delay. Thus, the live stream delay can be reduced.

It should be noted that FIG. 1 just exemplarily illustrates an application scenario of the embodiments of the present disclosure and not limits the application scenario of the embodiments of the present disclosure.

The technical solutions of the present disclosure and how the technical solutions of the present disclosure solve the above technical problems are explained in detail below in specific embodiments. The following several specific embodiments may be combined with each other, and the same or similar concepts or processes may not be repeated in some embodiments. The embodiments of the present disclosure will be described below with reference to the drawings.

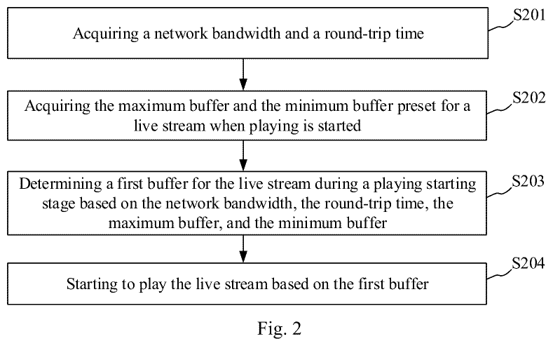

FIG. 2 is a schematic flowchart of a live stream processing method provided by the embodiments of the present disclosure. Referring to FIG. 2, the video processing method may include the following steps.

S201: acquiring a network bandwidth and a round-trip time.

The execution subject of the embodiment of the present disclosure may be a terminal device, or may be a live stream processing apparatus provided in a terminal device. For example, the live stream processing apparatus may be implemented based on software, or the live stream processing apparatus may be implemented based on a combination of software and hardware, which is not limited by the embodiments of the present disclosure.

The network bandwidth may be the current network bandwidth of the terminal device. For example, the network bandwidth may be a real-time network bandwidth of the terminal device. The terminal device may collect network bandwidth data within a preset time window, thereby obtaining the current network bandwidth. For example, the preset time window may be 10 seconds, and the terminal device may obtain the current network bandwidth per 10 seconds.

The round-trip time may be the current round-trip time of the terminal device. For example, the round-trip time may be a real-time round-trip time of the terminal device. The terminal device may collect the round-trip time within a preset time window, thereby obtaining the current round-trip time. For example, the preset time window may be 10 seconds. That is, the terminal device may obtain the current round-trip time per 10 seconds.

It should be noted that the terminal device may acquire the real-time network bandwidth and the real-time round-trip time of the terminal device based on any feasible implementation, which is not limited by the embodiments of the present disclosure.

S202: acquiring the maximum buffer and the minimum buffer preset for a live stream when playing is started.

The maximum buffer may indicate the maximum data volume of the live stream buffered when playing is started. For example, in response to the maximum buffer being 500 ms, the playing duration corresponding to the maximum data volume of the live stream buffered when playing is started may be 500 ms. In response to the maximum buffer being 1000 ms, the playing duration corresponding to the maximum data volume of the live stream buffered when playing is started may be 1000 ms.

The minimum buffer may indicate the minimum data volume of the live stream buffered when playing is started. For example, in response to the minimum buffer is 0 ms, the live stream data does not need to be buffered for the live stream when playing is started. For example, in response to the minimum buffer being 10 ms, the playing duration corresponding to the minimum data volume of the live stream buffered when playing is started may be 10 ms.

It should be noted that the maximum buffer and the minimum buffer in the embodiments of the present disclosure may be preset values, and the maximum buffer and the minimum buffer may be any values, which are not be limited by the embodiments of the present disclosure. For example, the preset maximum buffer may be 500 ms and the preset minimum buffer may be 0 ms; or the preset maximum buffer may be 1000 ms and the preset minimum buffer may be 100 ms, and so on.

S203: determining a first buffer for the live stream during a playing starting stage based on the network bandwidth, the round-trip time, the maximum buffer, and the minimum buffer.

The first buffer may be the buffer of the live stream during the playing starting stage. For example, in response to the first buffer being 100 ms, the buffer of the live stream during the playing starting stage is 100 ms; and in response to the first buffer being 500 ms, the buffer of the live stream during the playing starting stage is 500 ms.

Optionally, the playing starting stage may be within 2 seconds after playing is started, and the playing starting stage may also be within 4 seconds after playing is started, which is not be limited by the embodiments of the present disclosure. For example, in response to the first buffer being 100 ms and the playing starting stage being within 4 seconds after playing is started, the buffer of the live stream from the start of playing to the fourth second is 100 ms.

The terminal device may determine the first buffer for the live stream during the playing starting stage based on the following feasible implementation: determining a network quality level based on the network bandwidth and the round-trip time; and determining the first buffer for the live stream during the playing starting stage based on the network quality level, the maximum buffer, and the minimum buffer. In this way, the terminal device may flexibly and accurately determine the buffer for the live stream during the playing starting stage in combination with network statuses of different clients. The flexibility of determining the buffer and the accuracy of the buffer are improved.

The network quality level is used to indicate the network status of the terminal device. The network quality level is directly proportional to the network status. For example, the network quality level may include a first level, a second level, a third level, and a fourth level, where the network status of the fourth level is superior to the network status of the third level; the network status of the third level is superior to the network status of the second level; and the network status of the second level is superior to the network status of the first level.

Optionally, there are the following 4 cases in which the terminal device determines the network quality level based on the network bandwidth and the round-trip time.

Case 1: the network bandwidth is less than or equal to a first preset bandwidth, and the round-trip time is greater than or equal to a first preset duration.

In response to the network bandwidth being less than or equal to the first preset bandwidth, and the round-trip time being greater than or equal to the first preset duration, the terminal device may determine the network quality level as the first level. For example, the first preset bandwidth may be 800 kb/s and the first preset duration may be 77 ms. In response to the network bandwidth being less than 800 kb/s and the round-trip time being greater than 77 ms, it indicates that the current network status of the terminal device is poor. Therefore, the network quality level is the first level.

Case 2: the network bandwidth being less than or equal to a second preset bandwidth and greater than the first preset bandwidth, and the round-trip time being greater than or equal to a second preset duration and less than the first preset duration.

In response to the network bandwidth being less than or equal to the second preset bandwidth and greater than the first preset bandwidth, and the round-trip time being greater than or equal to the second preset duration and less than the first preset duration, the terminal device may determine the network quality level as the second level. For example, the second preset bandwidth may be 2300 kb/s and the second preset duration may be 46 ms. In response to the network bandwidth being greater than 800 kb/s and less than or equal to 2300 kb/s, and the round-trip time being greater than or equal to 46 ms and less than 77 ms, it indicates that the current network status of the terminal device is superior to the network status in the case 1. Therefore, the network quality level may be the second level.

Case 3: the network bandwidth is less than or equal to a third preset bandwidth and greater than the second preset bandwidth, and the round-trip time is greater than or equal to a third preset duration and less than the second preset duration.

In response to the network bandwidth being less than or equal to the third preset bandwidth and greater than the second preset bandwidth, and the round-trip time being greater than or equal to the third preset duration and less than the second preset duration, the terminal device may determine the network quality level as the third level. For example, the third preset bandwidth may be 3000 kb/s and the third preset duration may be 23 ms. In response to the network bandwidth being less than or equal to 3000 kb/s and greater than 2300 kb/s and the round-trip time being greater than or equal to 23 ms and less than 46 ms, it indicates that the current network status of the terminal device is superior to the network status in the case 1. Therefore, the network quality level may be the third level.

Case 4: the network bandwidth is greater than the third preset bandwidth and the round-trip time is less than the third preset duration.

In response to the network bandwidth being greater than the third preset bandwidth, and the round-trip time being less than the third preset duration, the terminal device may determine the network quality level as the fourth level. For example, in response to the network bandwidth being greater than 3000 kb/s and the round-trip being less than 23 ms, it indicates that the current network status of the terminal device is good and the current network status is superior to the network status in the case 3. Therefore, the terminal device may determine the network quality level as the fourth level.

In this way, the terminal device may grade the network status of the terminal device based on the network bandwidth and the round-trip time. Thus, the accuracy of determining the first buffer may be improved.

It should be noted that the network quality level determined with the network bandwidth and the round-trip time may be downward compatible. For example, in response to the network bandwidth being greater than 3000 kb/s and the round-trip time being greater than or equal to 23 ms and less than 46 ms, the terminal device may be downward compatible with the network quality level based on the case 3 and the case 4. Because the round-trip time conforms to the third level, the terminal device may determine the network quality level as the third level.

It should be noted that the network quality level determined with the network bandwidth and the round-trip time may also be upward compatible. For example, in response to the network bandwidth being greater than 3000 kb/s and the round-trip time being greater than or equal to 23 ms and less than 46 ms, the terminal device may be upward compatible with the network quality level based on the case 3 and the case 4. Because the network bandwidth conforms to the fourth level, the terminal device may determine the network quality level as the fourth level.

Optionally, the terminal device may calculate the network bandwidth and the round-trip time to obtain a target parameter and then determine the network quality level according to the target parameter. For example, the terminal device may determine a ratio of the network width to the round-trip time as the target parameter. The greater the target parameter, the better the network status; and the less the target parameter, the worse the network status. For example, in response to the ratio of the network width to the round-trip time being less than a first threshold, the terminal device may determine the network quality level as the first level. In response to the ratio of the network width to the round-trip time being greater than or equal to the first threshold and less than a second threshold, the terminal device may determine the network quality level as the second level. In response to the ratio of the network width to the round-trip time being greater than or equal to the second threshold and less than a third threshold, the terminal device may determine the network quality level as the third level. In response to the ratio of the network width to the round-trip time being greater than or equal to the third threshold, the terminal device may determine the network quality level as the fourth level.

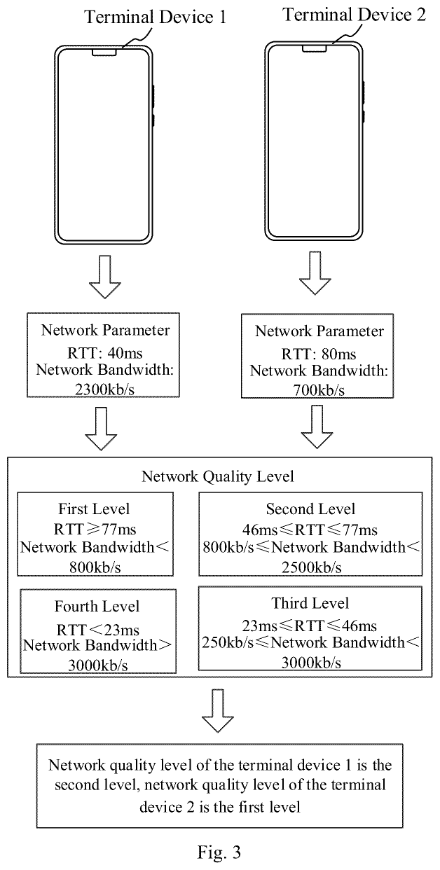

The process of determining the network quality level is described below with reference to FIG. 3.

FIG. 3 is a schematic diagram of a process of determining the network quality level provided by the embodiments of the present disclosure. Referring to FIG. 3, terminal device 1 and terminal device 2 are included. Network parameters of the terminal device 1 include: the round-trip time (RTT) is 40 ms, and the network bandwidth is 2300 kb/s. Network parameters of the terminal device 2 include: the RTT is 80 ms, and the network bandwidth is 700 kb/s. The network quality level includes a first level, a second level, a third level, and a fourth level, where the network status of the fourth level is superior to the network status of the third level; the network status of the third level is superior to the network status of the second level; and the network status of the second level is superior to the network status of the first level.

Referring to FIG. 3, because the network parameters RTT and network bandwidth of the terminal device 1 are within the ranges of the RTT and the network bandwidth at the second level, the network quality level of the terminal device 1 is the second level. Because the network parameters RTT and network bandwidth of the terminal device 2 are within the ranges of the RTT and the network bandwidth at the first level, the network quality level of the terminal device 2 is the first level. That is, the network status of the terminal device 1 is superior to the network status of the terminal device 2. In this way, the terminal device may accurately determine the current network quality level and thus can accurately set the first buffer for the live stream during the playing starting stage, thereby improving the accuracy of the first buffer.

Optionally, after the terminal device determines the network quality level, a suitable first buffer during the playing starting stage may be configured for the terminal device based on the network quality level, the maximum buffer, and the minimum buffer. In this way, because the first buffer is associated with the network status, the accuracy and flexibility of determining the first buffer may be improved.

S204: starting to play the live stream based on the first buffer.

The terminal device may start to play the live stream based on the following feasible implementation: acquiring the current buffer of the live stream; in response to the current buffer of the live stream being greater than or equal to the first buffer, starting to play the live stream; and in response to the current buffer of the live stream being less than the first buffer, waiting until the current buffer of the live stream is equal to the first buffer, or waiting for a fourth preset duration, before starting to play the live stream.

Optionally, the terminal device may acquire the current buffer of the live stream based on any feasible implementation, which is not be limited by the embodiments of the present disclosure.

Optionally, when a player of the terminal device renders the first frame of image of the live stream, in response to the current buffer of the live stream being greater than or equal to the first buffer, it indicates that the live stream data volume that has been buffered by the terminal device meets the buffered data volume required during the playing starting stage of the live stream. Therefore, the terminal device may play the live stream. For example, the first buffer is 100 ms. In response to that live stream data of 110 ms has been buffered when the terminal device renders the first frame of the live stream, the terminal may start to play the live stream. In this way, live stream stuttering may be avoided during the playing starting stage of the live stream.

Optionally, when the player of the terminal device renders the first frame of image of the live stream, in response to the current buffer of the live stream being less than the first buffer, it indicates that the live stream data volume that has been buffered by the terminal device does not meet the buffered data volume required during the playing starting stage of the live stream. In response to the terminal device starting to play the live stream, stuttering may occur during the playing starting stage. Therefore, the terminal device may wait for the current buffer being equal to the first buffer and then start to play the live stream. For example, in response to the first buffer being 100 ms, and that live stream data of 80 ms has been buffered when the terminal device renders the first frame of the live stream, the terminal also needs to buffer live stream data of 20 ms and then starts to play the live stream. For example, the fourth preset duration may be 1 second. In response to the current buffer of the live stream being less than the first buffer and the current buffer of the live stream after 1 second being still less than the first buffer, the terminal device may start to play the live stream. In this way, the problem of poor user experience due to a too long waiting time can be avoided.

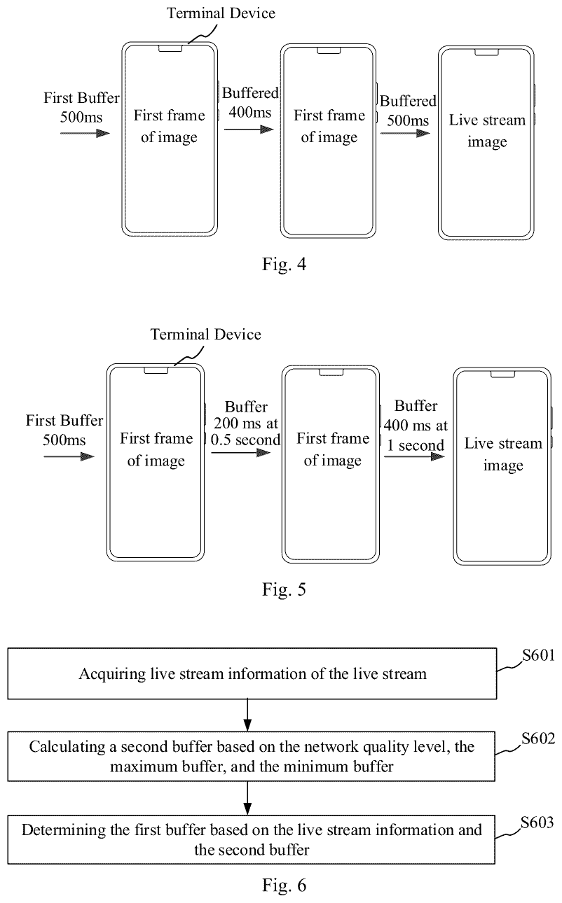

The process of starting to play the live stream by the terminal device based on the first buffer is described below with reference to FIG. 4 to FIG. 5.

FIG. 4 is a schematic diagram of starting to play a live stream provided by the embodiments of the present disclosure. Referring to FIG. 4, a terminal device is included. The first buffer is 500 ms. When the player of the terminal device renders the first frame of image, the display interface of the terminal device may include the first frame of image of the live stream. When the terminal device has buffered live stream data of 400 ms, the display interface of the terminal device still includes the first frame of image of the live stream. When the terminal device has buffered live stream data of 500 ms, the terminal device may start to play the live stream, and the display interface of the terminal device may include live stream images.

FIG. 5 is another schematic diagram of starting to play a live stream provided by the embodiments of the present disclosure. Referring to FIG. 5, a terminal device is included. The first buffer is 500 ms. When the player of the terminal device renders the first frame of image, the display interface of the terminal device may include the first frame of image of the live stream. The terminal device buffers live stream data of 200 ms at 0.5 second after the user clicks on the live stream, and the display interface of the terminal device still includes the first frame of image of the live stream. The terminal device buffers live stream data of 400 ms at 1 second after the user clicks on the live stream. Although the current buffer of the terminal device does not reach 500 ms, the terminal device may start to play the live stream in order to avoid the user from waiting for the live stream because 1 second has elapsed after the user clicks on the live stream. The display interface of the terminal device may include live stream images.

The embodiments of the present disclosure provide a live stream processing method. The terminal device may acquire a network bandwidth and a round-trip time and acquire the maximum buffer and the minimum buffer preset for a live stream when playing is started. The network quality level is determined based on the network bandwidth and the round-trip time. A first buffer of the live stream when playing is started is determined based on the network quality level, the maximum buffer, and the minimum buffer. In response to the current buffer being greater than or equal to the first buffer, the terminal device may start to play the live stream. In response to the current buffer being smaller than the first buffer, the terminal device may wait until the current buffer of the live stream is equal to the first buffer, or wait for 1 second, before starting to play the live stream. In this way, because the first buffer is determined based on the network status, the accuracy of the first buffer is high. For a user for whom a network status is good, the network bandwidth can be saved. Moreover, because the terminal device optimizes only the buffer during the playing starting stage, the live stream buffer after starting to play may not be affected. Therefore, a low value may be set for the live stream buffer after starting to play. Thus, not only can live stream stuttering be avoided, but also the live stream delay can be reduced. The user experience is enhanced.

On the basis of the embodiment shown in FIG. 2, the method of determining the first buffer for the live stream during the playing starting stage based on the network quality level, the maximum buffer, and the minimum buffer in the above-mentioned live stream processing method is described below with reference to FIG. 6.

FIG. 6 is a schematic diagram of a method of determining a first buffer provided by the embodiments of the present disclosure. Referring to FIG. 6, the method includes the following steps.

S601: acquiring live stream information of the live stream.

Optionally, the live stream information includes information regarding whether the live stream is the first live stream and information regarding whether a playing retrying request is made to the live stream. The information regarding whether the live stream is the first live stream may be used to indicate whether the live stream is the first live stream after the terminal device starts the live stream application. For example, in response to the first live stream after the terminal device starts the live stream application being live stream 1, the live stream information of the live stream 1 may include: being the first live stream. In response to the second live stream after the terminal device starts the live stream application being live stream 2, the live stream information of the live stream 2 may include: being not the first live stream.

The information regarding whether the playing retrying request is made to the live stream may be used to indicate whether a request for retrying playing is made to the live stream. For example, after the terminal device starts the live stream 1, in response to the live stream 1 reporting an error and the terminal device requesting to retry playing the live stream 1, the live stream information of the live stream 1 may include: a playing retrying request being made. In response to that the terminal device does not request to retry playing the live stream 2 when the terminal device starts the live stream 2, the live stream information of the live stream 2 may include: no playing retrying request being made.

It should be noted that the terminal device may determine the live stream information of the live stream based on any feasible implementation (e.g., acquiring the live stream information of the live stream based on the log of the live stream application), which is not limited by the embodiments of the present disclosure.

S602: calculating a second buffer based on the network quality level, the maximum buffer, and the minimum buffer.

Optionally, the terminal device may determine the second buffer based on the network quality level. For example, the terminal device may acquire a correspondence between the network quality level and the second buffer and determine the second buffer based on the network quality level and the correspondence, and the correspondence between the network quality level and the second buffer may include at least one network quality level, and the second buffer corresponding to each network quality level. For example, the correspondence between the network quality level and the second buffer may be as shown in Table 1.

TABLE 1

| Network Quality Level | Second Buffer |
|---|---|
| First level | Buffer 1 |
| Second level | Buffer 2 |
| Third level | Buffer 3 |
| Fourth level | Buffer 4 |

It should be noted that Table 1 merely illustrates the correspondence between the network quality level and the second buffer by way of example, rather than limits the correspondence between the network quality level and the second buffer.

For example, in response to the network quality level of the terminal device being the first level, the terminal device may determine the second buffer as the buffer 1. In response to the network quality level of the terminal device being the second level, the terminal device may determine the second buffer as the buffer 2. In response to the network quality level of the terminal device being the third level, the terminal device may determine the second buffer as the buffer 3. In response to the network quality level of the terminal device being the fourth level, the terminal device may determine the second buffer as the buffer 4.

Optionally, the terminal device calculates the second buffer based on the following formula:

$${y}_{x} = {y}_{min} + \frac{{( 4 - x )}^{1 / 3}}{{\sum }_{i = 1}^{4} {( 4 - i )}^{1 / 3}} * ( {y}_{max} - {y}_{min} ) ,$$

where yₓ represents the second buffer; yₘᵢₙ represents the minimum buffer; yₘₐₓ represents the maximum buffer; and x represents the network quality level (x of the first level is 1, x of the second level is 2, x of the third level is 3, and x of the fourth level is 4).

In this way, the terminal device may substitute the network quality level, the maximum buffer, and the minimum buffer into the above formula and thus can obtain the second buffer corresponding to each network quality level. Because the second buffer is related to the network quality, the flexibility and accuracy of the second buffer are high.

S603: determining the first buffer based on the live stream information and the second buffer.

There are the following 4 cases in which the terminal device determines the first buffer based on the live stream information and the second buffer.

Case 1: the live stream information indicates that the live stream is the first live stream and no playing retrying request is made to the live stream.

In response to the live stream information indicating that the live stream is the first live stream and no playing retrying request is made to the live stream, the terminal device may acquire a first stutter count and a first playing retrying request count of a user watching a live stream during a historical period, and determine the first buffer based on the first stutter count, the first playing retrying request count, and the second buffer. For example, in response to the live stream information indicating that the live stream is the first live stream, the live stream is the first live stream after the terminal device starts the live stream application, and there is no information associated with the previous live stream. Moreover, because no playing retrying request is made to the live stream, there is no information associated with the current live stream. Therefore, the terminal device may acquire the first stutter count and the first playing retrying request count of the user watching a plurality of live streams during the historical period. In this way, the terminal device may determine the habit of the user watching the live stream based on the first stutter count and the first playing retrying request count. Thus, the accuracy of the second buffer may be improved.

The first stutter count may be a total stutter count of the live stream watched by the user during the historical period. For example, in response to the stutter count of the user watching the live stream 1 during the historical period is 10 and the stutter count of the user watching the live stream 2 is 20, the first stutter count may be 30.

The first playing retrying request count may be a total playing retrying request count of the user watching the live stream during the historical period. For example, in response to the playing retrying request count of the user watching the live stream 1 during the historical period is 1 and the playing retrying request count of the user watching the live stream 2 is 2, the first playing retrying request count is 3.

It should be noted that the terminal device may acquire the first stutter count and the first playing retrying request count based on any feasible implementation, which is not limited by the embodiments of the present disclosure.

It should be noted that the historical period in the embodiments of the present disclosure may be a latest historical period or may be any historical period, which is not limited by the embodiments of the present disclosure.

Optionally, determining, by the terminal device, the first buffer based on the first stutter count, the first playing retrying request count, and the second buffer may specifically include: calculating a third buffer based on the first stutter count and the first playing retrying request count; and adding the third buffer to the second buffer to obtain the first buffer.

Optionally, the terminal device may calculate the third buffer based on the following formula:

$${y}_{x - offset} = \{ \begin{matrix}2 * ( \frac{1}{1 + {e}^{- count}} - 0.5 ) * ( {y}_{x} - {y}_{x + 1} ) \\ {y}_{x + 1 - offset} , count > 20\end{matrix} ,$$

where y_{x-offset} represents the third buffer; yₓ and yₓ₊₁ represent the second buffers; x represents the network quality level (the first level is 1, the second level is 2, the third level is 3, and the fourth level is 4); and count represents a weighting count of the first stutter count and the first playing retrying request count, and a weighting calculation method is as follows:

$$count = A * α + B * β ,$$

where A represents the first stutter count; B represents the first playing retrying request count; and α and β represent preset coefficients (e.g., a may be 0.42 and β may be 0.58; the two coefficients may be determined by the first stutter count and the first playing retrying request count, which are not limited by the embodiments of the present disclosure).

In this case, in response to the live stream being the first live stream and no playing retrying request being made to the live stream, the terminal device may determine the first buffer in combination with the habit (e.g., easy stuttering or not easy stuttering) of the user watching the live stream during the historical period. Thus, the accuracy of the first buffer may be improved.

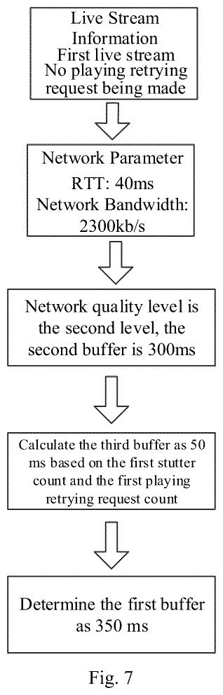

The process of determining the first buffer in this case is described below with reference to FIG. 7.

FIG. 7 is a schematic diagram of a process of determining the first buffer provided by the embodiments of the present disclosure. Referring to FIG. 7, live stream information of a live stream is included. The live stream information may include: first live stream, and no playing retrying request being made. The network parameters of the terminal device (not shown in FIG. 7) may include: RTT is 40 ms; and the network bandwidth is 2300 kb/s. Therefore, the terminal device may determine the network quality level as the second level and may determine the second buffer corresponding to the second level as 300 ms. The terminal device may acquire a first stutter count and a first playing retrying request count of a live stream during a historical period, and calculate the third buffer as 50 ms based on the first stutter count and the first playing retrying request count. The terminal device may add the second buffer to the third buffer to obtain the first buffer as 350 ms.

In this way, the terminal device may determine the second buffer in combination with the network status and improve the accuracy of the second buffer. Moreover, the terminal device may adjust the second buffer in combination with the habit of the user watching the live stream. Thus, the accuracy of the first buffer may be improved.

Case 2: the live stream information indicates that the live stream is the first live stream and the playing retrying request is made to the live stream.

In response to the live stream information indicating that the live stream is the first live stream and the playing retrying request is made to the live stream, the terminal device may acquire a second stutter count and a second playing retrying request count of the user watching the live stream, and determine the first buffer based on the second stutter count, the second playing retrying request count, and the second buffer.

The second stutter count may be a stutter count of the user watching the current live stream, and the second playing retrying request count may be a playing retrying request count of the user watching the current live stream. For example, because the live stream information of the live stream includes the playing retrying request being made to the live stream, the live stream has historical live stream data, and because the historical live stream data is the latest live stream data, the reliability of the historical live stream data is high. The terminal device can determine the second stutter count and the second playing retrying request count from the historical live stream data. Thus, the accuracy of the first buffer may be improved.

For example, when the user watches a live stream, the live stream reports an error, causing the terminal device to request to play the live stream again. When the terminal device restarts the live stream, the user has watched the live stream for a duration. Therefore, a stutter count in the duration may be the second stutter count, and a playing retrying request count in the duration may be the second playing retrying request count.

It should be noted that the terminal device may determine the second stutter count and the second playing retrying request count based on any feasible implementation, which is not limited by the embodiments of the present disclosure.

Optionally, determining, by the terminal device, the first buffer based on the second stutter count, the second playing retrying request count, and the second buffer may include: calculating, by the terminal device, one buffer based on the second stutter count and the second playing retrying request count, and adding the buffer to the second buffer to obtain the first buffer.

It should be noted that the process of determining, by the terminal device, one buffer based on the second stutter count and the second playing retrying request count is the same as the process of determining, by the terminal device, the third buffer based on the first stutter count and the first playing retrying request count, which is not described redundantly in the embodiments of the present disclosure.

In this case, because the playing retrying request has been made to the live stream, the live stream has a piece of live stream data. Because the reliability of this piece of live stream data is high, the terminal device adjusts the second buffer based on this piece of live stream data, and the accuracy of the obtained first buffer is high.

Case 3: the live stream information indicates that the live stream is not the first live stream and no playing retrying request is made to the live stream.

In response to the live stream information indicating that the live stream is not the first live stream and no playing retrying request is made to the live stream, the terminal device may acquire a third stutter count and a third playing retrying request count of a previous live stream, and determine the first buffer based on the third stutter count, the third playing retrying request count, and the second buffer.

The third stutter count may be a stutter count corresponding to the previous live stream, and the third playing retrying request count may be a playing retrying request count corresponding to the previous live stream. For example, after the terminal device starts the live stream application, the terminal device plays the live stream 1. After the playing of the live stream 1 is finished, the terminal device plays the live stream 2, and the live stream information of the live stream 2 includes being not the first live stream. In response to the stutter count of the live stream 1 during live streaming being 10 and the playing retrying request count being 3, the terminal device may determine that the third stutter count is 10 and the third playing retrying request count is 3.

For example, when the terminal device is ready to play the non-first live stream (i.e., a live stream other than the first live stream), because the live stream data of the previous live stream is the latest live stream data, the reliability of the live stream data of the previous live stream is high. Therefore, the terminal device adjusts the second buffer in combination with the live stream data of the previous live stream, and the accuracy of the obtained first buffer is high.

It should be noted that the terminal device may determine the third stutter count and the third playing retrying request count based on any feasible implementation, which is not limited by the embodiments of the present disclosure.

Determining, by the terminal device, the first buffer based on the third stutter count, the third playing retrying request count, and the second buffer may include: calculating a fourth buffer based on the third stutter count and the third playing retrying request count; acquiring a duration between the end of the previous live stream and the current time; determining a weight based on the duration between the end of the previous live stream and the current time; and multiplying the fourth buffer by the weight to obtain a fifth buffer, and adding the fifth buffer to the second buffer to obtain the first buffer.

It should be noted that the process of calculating, by the terminal device, the fourth buffer based on the third stutter count and the third playing retrying request count is the same as the process of calculating, by the terminal device, the third buffer based on the first stutter count and the first playing retrying request count, which is not described redundantly in the embodiments of the present disclosure.

For example, the current live stream is the live stream 1 and the previous live stream is the live stream 2. In response to the terminal device being ready to play the current live stream 3 seconds later after the live stream 2 is finished, the terminal device may determine that the duration between the end of the previous live stream and the current time to be 3 seconds.

Optionally, the terminal device may determine the weight based on the following formula:

$$w = \frac{1}{{e}^{0.1 * delta}} ,$$

where w represents the weight, and delta represents the duration between the end of the previous live stream and the current time.

For example, in response to the second buffer being 100 ms, the fourth buffer calculated by the terminal device based on the third stutter count and the third playing retrying request count being 30 ms and the weight being 0.5, the terminal device may determine the fifth buffer as 15 ms and thus may determine the first buffer as 115 ms.

In this case, because the habit of the user watching the live stream varies time, the further the live stream data is from the current time, the lower the reliability, and the closer the live stream data is to the current time, the higher the reliability. The terminal device adjusts the fourth buffer in combination with the weight so that the accuracy of the first buffer may be improved.

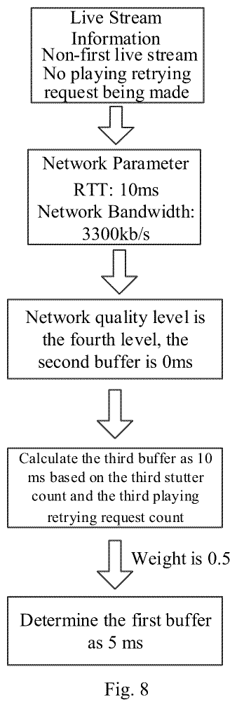

The process of determining the first buffer in this case is described below with reference to FIG. 8.

FIG. 8 is a schematic diagram of another process of determining the first buffer provided by the embodiments of the present disclosure. Referring to FIG. 8, live stream information of a live stream is included. The live stream information may include: non-first live stream (i.e., a live stream other than the first live stream), and no playing retrying request being made. The network parameters of the terminal device (not shown in FIG. 8) may include: RTT is 10 ms; and the network bandwidth is 3300 kb/s. Therefore, the terminal device may determine the network quality level as the fourth level and may determine the second buffer corresponding to the fourth level as 0 ms. The terminal device may acquire a third stutter count and a third playing retrying request count of a previous live stream, and calculate a fourth buffer as 10 ms based on the third stutter count and the third playing retrying request count. The terminal device determines the weight as 0.5 based on the duration between the end of the previous live stream and the current time. Therefore, the terminal device may multiply the fourth buffer by the weight and add the result to the second buffer to obtain the first buffer as 0 ms.

Case 4: the live stream information indicates that the live stream is not the first live stream and the playing retrying request is made to the live stream.

In response to the live stream information indicating that the live stream is a non-first live stream (i.e., a live stream other than the first live stream) and the playing retrying request is made to the live stream, a fourth stutter count and a fourth playing retrying request count of a previous live stream and the live stream are acquired, and the first buffer is determined based on the fourth stutter count, the fourth playing retrying request count, and the second buffer.

The fourth stutter count may be a sum of stutter counts of the previous live stream and the current live stream, and the fourth playing retrying request count may be a sum of playing retrying request counts of the previous live stream and the current live stream. For example, in response to the live stream information indicating that the live stream is a non-first live stream and the playing retrying request is made to the live stream, the terminal device has the live stream data of the previous live stream, and the terminal device also has a piece of live stream data of the current live stream and thus may determine the fourth stutter count and the fourth playing retrying request count based on the live stream data of the previous live stream and the piece of live stream data of the current live stream.

For example, the terminal device currently requests to play the live stream 1 again; the previous live stream to the live stream 1 is the live stream 2; the stutter count of the live stream 2 during live streaming is 30 and the playing retrying request count is 3; and the stutter count of the live stream 1 is 10 before currently requesting for playing again and the playing retrying request count is 2. Thus, the terminal device may determine the fourth stutter count as 40 and the fourth playing retrying request count as 5.

It should be noted that the terminal device may determine the fourth stutter count and the fourth playing retrying request count based on any feasible implementation, which is not limited by the embodiments of the present disclosure.

Optionally, the process of determining, by the terminal device, the first buffer based on the fourth stutter count, the fourth playing retrying request count, and the second buffer is the same as the process of determining, by the terminal device, the first buffer based on the third stutter count, the third playing retrying request count, and the second buffer, which is not described redundantly in the embodiments of the present disclosure.

In this case, because the terminal device has the live stream data of the previous live stream and the live stream data of the current live stream, and the terminal device may determine an attenuating weight in combination with the duration between the end of the previous live stream and the current time, the terminal device may adjust the second buffer in combination with the above-mentioned live stream data and the attenuating weight. Thus, the accuracy of the first buffer may be improved.

The embodiments of the present disclosure provide a method of determining the first buffer. The live stream information of the live stream is acquired. The second buffer is calculated based on the network quality level, the maximum buffer, and the minimum buffer. The first buffer is determined based on the live stream information and the second buffer. In this way, the terminal device may determine different scenarios based on the live stream information and then determine the first buffer corresponding to each scenario. The flexibility of determining the first buffer and the accuracy of determining the first buffer are improved.

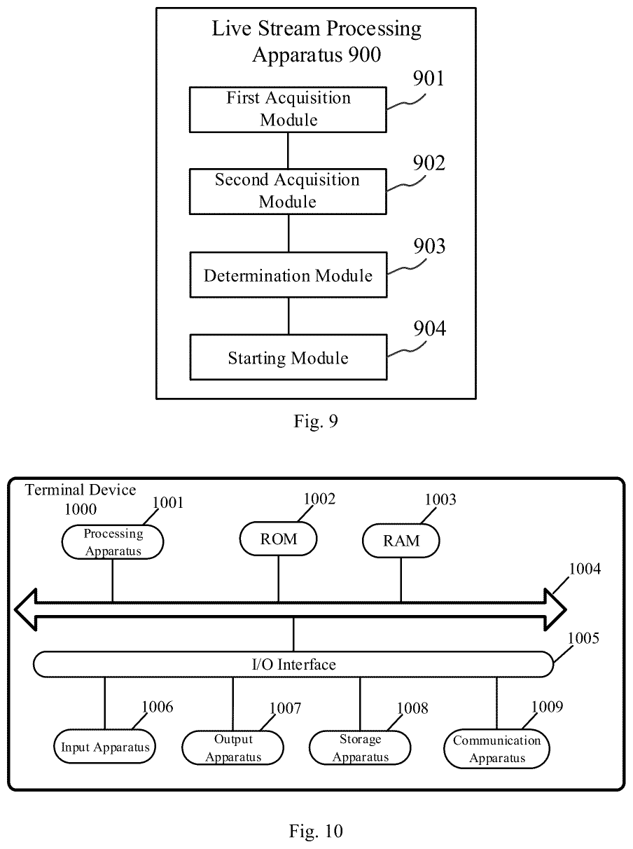

FIG. 9 is a schematic structural diagram of a live stream processing apparatus provided by the embodiments of the present disclosure. Please refer to FIG. 9, the live stream processing apparatus 900 includes a first acquisition module 901, a second acquisition module 902, a determination module 903, and a starting module 904.

The first acquisition module 901 is configured to acquire a network bandwidth and a round-trip time.

The second acquisition module 902 is configured to acquire a maximum buffer and a minimum buffer preset for a live stream when playing is started.

The determination module 903 is configured to determine a first buffer for the live stream during a playing starting stage based on the network bandwidth, the round-trip time, the maximum buffer, and the minimum buffer.

The starting module 904 is configured to start to play the live stream based on the first buffer.

According to one or more embodiments, the determination module 903 is configured to:
determine a network quality level based on the network bandwidth and the round-trip time; and
determine the first buffer for the live stream during the playing starting stage based on the network quality level, the maximum buffer, and the minimum buffer.

According to one or more embodiments, the determination module 903 is configured to:
in response to the network bandwidth being less than or equal to a first preset bandwidth and the round-trip time being greater than or equal to a first preset duration, determine the network quality level as a first level;
in response to the network bandwidth being less than or equal to a second preset bandwidth and greater than the first preset bandwidth, and the round-trip time being greater than or equal to a second preset duration and less than the first preset duration, determine the network quality level as a second level;
in response to the network bandwidth being less than or equal to a third preset bandwidth and greater than the second preset bandwidth, and the round-trip time being greater than or equal to a third preset duration and less than the second preset duration, determine the network quality level as a third level; and
in response to the network bandwidth being greater than the third preset bandwidth and the round-trip time being less than the third preset duration, determine the network quality level as a fourth level;
the network quality level is directly proportional to network status.

According to one or more embodiments, the determination module 903 is configured to:
acquire live stream information of the live stream, in which the live stream information includes information regarding whether the live stream is a first live stream and information regarding whether a playing retrying request is made to the live stream;
calculate a second buffer based on the network quality level, the maximum buffer, and the minimum buffer; and
determine the first buffer based on the live stream information and the second buffer.

According to one or more embodiments, the determination module 903 is configured to:
in response to the live stream information indicating that the live stream is the first live stream and no playing retrying request is made to the live stream, acquire a first stutter count and a first playing retrying request count of a user watching a live stream during a historical period, and determine the first buffer based on the first stutter count, the first playing retrying request count, and the second buffer;
in response to the live stream information indicating that the live stream is the first live stream and the playing retrying request is made to the live stream, acquire a second stutter count and a second playing retrying request count of the user watching the live stream, and determine the first buffer based on the second stutter count, the second playing retrying request count, and the second buffer;
in response to the live stream information indicating that the live stream is not the first live stream and no playing retrying request is made to the live stream, acquire a third stutter count and a third playing retrying request count of a previous live stream, and determine the first buffer based on the third stutter count, the third playing retrying request count, and the second buffer; and
in response to the live stream information indicating that the live stream is not the first live stream and the playing retrying request is made to the live stream, acquire a fourth stutter count and a fourth playing retrying request count of a previous live stream and the live stream, and determine the first buffer based on the fourth stutter count, the fourth playing retrying request count, and the second buffer.

According to one or more embodiments, the determination module 903 is configured to:
calculate a third buffer based on the first stutter count and the first playing retrying request count; and
add the third buffer to the second buffer to obtain the first buffer.

According to one or more embodiments, the determination module 903 is configured to:
calculate a fourth buffer based on the third stutter count and the third playing retrying request count;
acquire a duration between the end of the previous live stream and the current time;
determine a weight based on the duration between the end of the previous live stream and the current time; and
multiply the fourth buffer by the weight to obtain a fifth buffer, and add the fifth buffer to the second buffer to obtain the first buffer.

According to one or more embodiments, the starting module 904 is configured to:
acquire the current buffer of the live stream;
in response to the current buffer of the live stream being greater than or equal to the first buffer, start to play the live stream; and
in response to the current buffer of the live stream being less than the first buffer, wait until the current buffer of the live stream is equal to the first buffer, or wait for a fourth preset duration, before starting to play the live stream.

The live stream processing apparatus provided by the embodiments of the present disclosure can be used to perform the technical solutions of the above-mentioned method embodiments, with similar implementation principles and technical effects. Detailed descriptions of these aspects are omitted in the present embodiment.

FIG. 10 is a schematic structural diagram of a terminal device provided by the embodiments of the present disclosure. Please refer to FIG. 10, which illustrates a schematic structural diagram of a terminal device 1000 suitable for implementing the embodiments of the present disclosure. The terminal device may include, but is not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The terminal device illustrated in FIG. 10 is merely an example, and should not pose any limitation to the functions and the range of use of the embodiments of the present disclosure.

As illustrated in FIG. 10, the terminal device 1000 may include a processing apparatus 1001 (e.g., a central processing unit, a graphics processing unit, etc.), which can perform various suitable actions and processing according to a program stored in a read-only memory (ROM) 1002 or a program loaded from a storage apparatus 1008 into a random-access memory (RAM) 1003. The RAM 1003 further stores various programs and data required for operations of the terminal device 1000. The processing apparatus 1001, the ROM 1002, and the RAM 1003 are interconnected through a bus 1004. An input/output (I/O) interface 1005 is also connected to the bus 1004.

Usually, the following apparatuses may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the terminal device 1000 to be in wireless or wired communication with other devices to exchange data. While FIG. 10 illustrates the terminal device 1000 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned terminal device, or may also exist alone without being assembled into the terminal device.

The above-mentioned computer-readable medium carries one or more programs, and when the one or more programs are executed by the terminal device, the terminal device is caused to perform the methods illustrated in the above-mentioned embodiments.

The embodiments of the present disclosure further provide a non-transitory computer-readable storage medium storing computer-executable instructions, which, when executed by a processor, implement the method as may be involved in the various possible embodiments described above.

The embodiments of the present disclosure further provide a computer program product, including a computer program, which, when executed by a processor, implements the method as may be involved in the various possible embodiments described above.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a “unit for acquiring at least two Internet Protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message. As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

Meanwhile, it may be understood that the data involved in the technical solutions (including but not limited to the data itself, data acquisition or use) should comply with the requirements of corresponding laws, regulations and relevant provisions. The data may include information, parameters, messages, and the like, such as cut flow indication information.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A live stream processing method, comprising:
acquiring a network bandwidth and a round-trip time;
acquiring a maximum buffer and a minimum buffer preset for a live stream when playing is started;
determining a first buffer for the live stream during a playing starting stage based on the network bandwidth, the round-trip time, the maximum buffer, and the minimum buffer; and
starting to play the live stream based on the first buffer.

2. The method according to claim 1, wherein the determining the first buffer for the live stream during the playing starting stage based on the network bandwidth, the round-trip time, the maximum buffer, and the minimum buffer comprises:
determining a network quality level based on the network bandwidth and the round-trip time; and
determining the first buffer for the live stream during the playing starting stage based on the network quality level, the maximum buffer, and the minimum buffer.

3. The method according to claim 2, wherein the determining the network quality level based on the network bandwidth and the round-trip time comprises:
in response to the network bandwidth being less than or equal to a first preset bandwidth and the round-trip time being greater than or equal to a first preset duration, determining the network quality level as a first level;
in response to the network bandwidth being less than or equal to a second preset bandwidth and greater than the first preset bandwidth, and the round-trip time being greater than or equal to a second preset duration and less than the first preset duration, determining the network quality level as a second level;
in response to the network bandwidth being less than or equal to a third preset bandwidth and greater than the second preset bandwidth, and the round-trip time being greater than or equal to a third preset duration and less than the second preset duration, determining the network quality level as a third level; and
in response to the network bandwidth being greater than the third preset bandwidth and the round-trip time being less than the third preset duration, determining the network quality level as a fourth level,
wherein the network quality level is directly proportional to network status.

4. The method according to claim 2, wherein the determining the first buffer for the live stream during the playing starting stage based on the network quality level, the maximum buffer, and the minimum buffer comprises:
acquiring live stream information of the live stream, wherein the live stream information comprises information regarding whether the live stream is a first live stream and information regarding whether a playing retrying request is made to the live stream;
calculating a second buffer based on the network quality level, the maximum buffer, and the minimum buffer; and
determining the first buffer based on the live stream information and the second buffer.

5. The method according to claim 4, wherein the determining the first buffer based on the live stream information and the second buffer comprises:
in response to the live stream information indicating that the live stream is the first live stream and no playing retrying request is made to the live stream, acquiring a first stutter count and a first playing retrying request count of a user watching a live stream during a historical period, and determining the first buffer based on the first stutter count, the first playing retrying request count, and the second buffer;
in response to the live stream information indicating that the live stream is the first live stream and the playing retrying request is made to the live stream, acquiring a second stutter count and a second playing retrying request count of the user watching the live stream, and determining the first buffer based on the second stutter count, the second playing retrying request count, and the second buffer;
in response to the live stream information indicating that the live stream is not the first live stream and no playing retrying request is made to the live stream, acquiring a third stutter count and a third playing retrying request count of a previous live stream, and determining the first buffer based on the third stutter count, the third playing retrying request count, and the second buffer; and
in response to the live stream information indicating that the live stream is not the first live stream and the playing retrying request is made to the live stream, acquiring a fourth stutter count and a fourth playing retrying request count of a previous live stream and the live stream, and determining the first buffer based on the fourth stutter count, the fourth playing retrying request count, and the second buffer.

6. The method according to claim 5, wherein the determining the first buffer based on the first stutter count, the first playing retrying request count, and the second buffer comprises:
calculating a third buffer based on the first stutter count and the first playing retrying request count; and
adding the third buffer to the second buffer to obtain the first buffer.

7. The method according to claim 5, wherein the determining the first buffer based on the third stutter count, the third playing retrying request count, and the second buffer comprises:
calculating a fourth buffer based on the third stutter count and the third playing retrying request count;
acquiring a duration between the end of the previous live stream and a current time;
determining a weight based on the duration between the end of the previous live stream and the current time; and
multiplying the fourth buffer by the weight to obtain a fifth buffer, and adding the fifth buffer to the second buffer to obtain the first buffer.

8. The method according to claim 1, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

9. The method according to claim 2, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

10. The method according to claim 3, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

11. The method according to claim 4, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

12. The method according to claim 5, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

13. The method according to claim 6, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

14. The method according to claim 7, wherein the starting to play the live stream based on the first buffer comprises:
acquiring a current buffer of the live stream;
in response to the current buffer of the live stream being greater than or equal to the first buffer, starting to play the live stream; and
in response to the current buffer of the live stream being less than the first buffer, waiting until the current buffer of the live stream is equal to the first buffer, or waiting for a fourth preset duration, before starting to play the live stream.

15. A terminal device, comprising a processor and a memory,
wherein the memory is configured to store computer-executable instructions; and
the processor is configured to execute the computer-executable instructions stored in the memory to implement a live stream processing method, and the live stream processing method comprises:
acquiring a network bandwidth and a round-trip time;
acquiring a maximum buffer and a minimum buffer preset for a live stream when playing is started;
determining a first buffer for the live stream during a playing starting stage based on the network bandwidth, the round-trip time, the maximum buffer, and the minimum buffer; and
starting to play the live stream based on the first buffer.

16. The terminal device according to claim 15, wherein the determining the first buffer for the live stream during the playing starting stage based on the network bandwidth, the round-trip time, the maximum buffer, and the minimum buffer comprises:
determining a network quality level based on the network bandwidth and the round-trip time; and
determining the first buffer for the live stream during the playing starting stage based on the network quality level, the maximum buffer, and the minimum buffer.

17. The terminal device according to claim 16, wherein the determining the network quality level based on the network bandwidth and the round-trip time comprises:
in response to the network bandwidth being less than or equal to a first preset bandwidth and the round-trip time being greater than or equal to a first preset duration, determining the network quality level as a first level;
in response to the network bandwidth being less than or equal to a second preset bandwidth and greater than the first preset bandwidth, and the round-trip time being greater than or equal to a second preset duration and less than the first preset duration, determining the network quality level as a second level;
in response to the network bandwidth being less than or equal to a third preset bandwidth and greater than the second preset bandwidth, and the round-trip time being greater than or equal to a third preset duration and less than the second preset duration, determining the network quality level as a third level; and
in response to the network bandwidth being greater than the third preset bandwidth and the round-trip time being less than the third preset duration, determining the network quality level as a fourth level,
wherein the network quality level is directly proportional to network status.

18. The terminal device according to claim 16, wherein the determining the first buffer for the live stream during the playing starting stage based on the network quality level, the maximum buffer, and the minimum buffer comprises:
acquiring live stream information of the live stream, wherein the live stream information comprises information regarding whether the live stream is a first live stream and information regarding whether a playing retrying request is made to the live stream;
calculating a second buffer based on the network quality level, the maximum buffer, and the minimum buffer; and
determining the first buffer based on the live stream information and the second buffer.

19. The terminal device according to claim 18, wherein the determining the first buffer based on the live stream information and the second buffer comprises:
in response to the live stream information indicating that the live stream is the first live stream and no playing retrying request is made to the live stream, acquiring a first stutter count and a first playing retrying request count of a user watching a live stream during a historical period, and determining the first buffer based on the first stutter count, the first playing retrying request count, and the second buffer;
in response to the live stream information indicating that the live stream is the first live stream and the playing retrying request is made to the live stream, acquiring a second stutter count and a second playing retrying request count of the user watching the live stream, and determining the first buffer based on the second stutter count, the second playing retrying request count, and the second buffer;
in response to the live stream information indicating that the live stream is not the first live stream and no playing retrying request is made to the live stream, acquiring a third stutter count and a third playing retrying request count of a previous live stream, and determining the first buffer based on the third stutter count, the third playing retrying request count, and the second buffer; and
in response to the live stream information indicating that the live stream is not the first live stream and the playing retrying request is made to the live stream, acquiring a fourth stutter count and a fourth playing retrying request count of a previous live stream and the live stream, and determining the first buffer based on the fourth stutter count, the fourth playing retrying request count, and the second buffer.

20. A non-transitory computer-readable storage medium, storing computer-executable instructions, wherein a processor, when executing the computer-executable instructions, implements a live stream processing method, and the live stream processing method comprises:
acquiring a network bandwidth and a round-trip time;
acquiring a maximum buffer and a minimum buffer preset for a live stream when playing is started;
determining a first buffer for the live stream during a playing starting stage based on the network bandwidth, the round-trip time, the maximum buffer, and the minimum buffer; and
starting to play the live stream based on the first buffer.
